(19) United States
(12) Patent Application Publication
(10) Pub. No.: US 2004/0157006 A1
(43) Pub. Date: Aug. 12, 2004

(54) Method of producing a magnetic disk

(75) Inventors: Takashi Sato, Singapore (SG); Kenji Ayama, Singapore (SG); Masafumi Ishiyama, Singapore (SG)

Correspondence Address: SUGHRUE MION, PLLC, 2100 PENNSYLVANIA AVENUE, N.W., SUITE 800, WASHINGTON, DC, 20037, US

(73) Assignees: HOYA CORPORATION; HOYA MAGNETICS SINGAPORE PTE. LTD.

(21) Appl. No.: 10/775,063

(22) Filed: Feb. 11, 2004

(30) Foreign Application Priority Data
Feb. 12, 2003 (JP) 33121/2003

(51) Int. Cl. B05D 5/12

(52) U.S. Cl. 427/577; 427/127

(57) ABSTRACT

After at least a magnetic layer is formed on a disk substrate, a carbon-based protection layer is formed by plasma CVD using a mixed gas of a hydrocarbon-based gas and a nitrogen gas under the condition that the temperature of the disk substrate with the magnetic layer formed thereon is higher than 200° C.

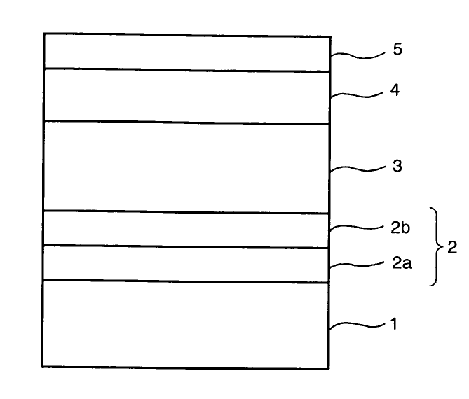

This application claims priority to prior Japanese application JP 2003-33121, the disclosure of which is incorporated herein by reference.

### BACKGROUND OF THE INVENTION

This invention relates to a method of producing a magnetic disk to be loaded in a magnetic disk apparatus, such as a HDD (hard disk drive), for recording information.

At present, following the development of the IT (information technology) industry, there is a demand for dramatic technical innovation in the information recording technology, in particular, in the magnetic recording technology. For example, in the field of a magnetic disk to be loaded in a magnetic disk apparatus such as a HDD, a technique capable of achieving an information recording density on the order of 40 Gbit/inch² to 100 Gbit/inch² and a yet higher density is required.

In the magnetic disk apparatus, use has been made of a CSS (Contact Start and Stop) system. In the CSS system, a magnetic head is kept in contact with a surface of a magnetic disk in an inner circumferential zone as a contact sliding zone when the magnetic disk apparatus is turned off. During start-up, the magnetic head slides over the inner circumferential zone in contact therewith and is slightly lifted up. When the magnetic head reaches a read/write zone located outside the inner circumferential zone, a read or a write operation is started. In the CSS system, the contact sliding zone must be provided on the magnetic disk in addition to the read/write zone.

Furthermore, in the CSS system, the surface of the magnetic disk is coated with a protection layer in order to protect the magnetic disk from the magnetic head which slides in contact with the magnetic disk.

In response to a recent demand for a higher recording density, various approaches have been made in order to achieve an information recording density of 40 Gbit/inch² or more. As one of the approaches, it is required to narrow a gap (magnetic spacing) between a magnetic layer of the magnetic disk and a read/write element of the magnetic head to 20 nm or less so that a spacing loss is decreased and an S/N ratio is improved.

In order to achieve the magnetic spacing of 20 nm or less, the protection layer of the magnetic disk is required to have a thickness as small as 6 nm or less. The flying height of the magnetic head must be reduced to 12 nm or less. Furthermore, it is desired to use, as a start/stop mechanism of the magnetic disk apparatus, a LUL (Load Unload, Ramp Load) system instead of the CSS system. The LUL system is advantageous in that the storage capacity can be increased. In the LUL system, the magnetic head is retreated and rests on an inclined support, called a ramp, located outside the magnetic disk when the magnetic disk apparatus is turned off. During start-up, the magnetic head slides in a flying state (i.e., in a non-contact state) from the ramp to a LUL zone above the surface of the magnetic disk after the rotation of the magnetic disk is started. Then, a read or a write operation is started. In the LUL system, the contact sliding zone for the magnetic head need not be provided on the surface of the magnetic disk, unlike the CSS system. Therefore, the read/write zone has a wide area and the storage capacity of the magnetic disk is increased as compared with the CSS system.

In order to assure a wear resistance and a sliding characteristic even if the protection layer of the magnetic disk is reduced in thickness to the above-mentioned extent, Japanese Patent Application Publication (JP-A) No. 2001-126233 discloses a method in which a carbon-hydrogen protection film is deposited by plasma CVD and is subjected to surface modification by introducing nitrogen ions through the surface of the film. Generally, when deposition is performed by plasma CVD, it is possible to obtain a film which contains a large amount of diamond-like carbon and is therefore dense and high in hardness.

Recently, however, there arises a problem that the magnetic disk apparatus loaded with the magnetic disk having the protection layer formed by plasma CVD is susceptible to a thermal asperity error. According to the study of the present inventors, it has been found out that, in case where the protection layer is formed by plasma CVD and if decomposition of hydrocarbons during plasma discharge is insufficient, a hydrocarbon-based organic polymer is adhered to the surface of the protection layer in the form of particles, resulting in occurrence of the thermal asperity error. It is noted here that the thermal asperity is a spike noise produced when a magnetic head having a magnetoresistive read element (such as MR (magnetoresistive), GMR (giant magnetoresistive), and TMR (tunneling magnetoresistive) elements) collides with protrusions on the magnetic disk. The thermal asperity is caused by instantaneous change in resistance value of the magnetoresistive read element due to the heat generated by collision and results in misreading of data, which is a serious unrecoverable error.

According to the study of the present inventors, it has also been found out that, since decomposition of hydrocarbons during plasma discharge is insufficient, an organic substance containing a large amount of polymer component is incorporated into the protection layer being deposited and, as a result, the strength of the protection layer is insufficient. If the strength of the protection layer is insufficient, there arises a problem, particularly in the magnetic disk apparatus of the LUL system, that a small flaw or the like is produced on the surface of the magnetic disk by the impact of the magnetic head and a readout signal is reduced in signal level. Furthermore, the read element of the magnetic head is contaminated so that the reading or the writing operation is impossible.

### SUMMARY OF THE INVENTION

It is therefore an object of this invention to provide a method of producing a magnetic disk which is prevented from a thermal asperity error and which is excellent in LUL durability and is suitable for use in the LUL system.

It is another object of this invention to provide a method of producing a magnetic disk which is prevented from a thermal asperity error and which can be reduced in thickness of a protection layer.

It is still another object of this invention to provide a method of producing a magnetic disk which is prevented from a thermal asperity error and which is suitable for reduction in flying height of a magnetic head.

In order to achieve the above-mentioned objects, the present inventors focused attention on a material gas used in plasma CVD and a depositing condition and were dedicated to their study. Based on the knowledge obtained as a result of the study, this invention has been completed.

Traditionally, as a material gas for forming a carbon protection layer by plasma CVD, a mixed gas of an inactive gas such as Ar and a hydrocarbon-based gas is used as described in the above-mentioned publication. It is also known to use a hydrocarbon-based gas alone as the material gas or to use a mixed gas of a hydrocarbon-based gas and a hydrogen gas as the material gas. In case where deposition is performed by plasma CVD using the above-mentioned material gas known in the art, hydrocarbons decomposed in plasma form a carbon-carbon bond or a carbon-hydrogen bond and the carbon protection layer is formed on a disk substrate. However, a part of hydrocarbons are not decomposed or insufficiently decomposed during the above-mentioned process but are aggregated and fused together to form polymer particles. The polymer particles are partly incorporated into the protection layer as a part thereof. The remaining polymer particles not incorporated into the protection layer are attached to an inner wall of a deposition chamber and, at a particular frequency or probability, drop down from the wall to be adhered to the surface of the protection layer as the particles. The particles adhered to the surface of the protection layer form protrusions causing the thermal asperity. Further, at positions where the polymer particles are incorporated into the protection layer, the film strength of the protection layer is significantly decreased so that the LUL durability required to the magnetic disk apparatus of a LUL system can not be obtained.

According to the study of the present inventors, it has been found out that, by depositing a carbon-based protection layer containing hydrogen and nitrogen by the use of a mixed gas of a hydrocarbon-based gas and a nitrogen gas as a material gas for forming the protection layer by plasma CVD without using an inactive gas such as Ar, it is possible to suppress adhesion of the hydrocarbon-based organic polymer to the surface of the protection layer in the form of particles. Presumably, this is because, by using the mixed gas of the hydrocarbon-based gas and the nitrogen gas without containing the inactive gas, production of the organic polymer compound causing the particles is suppressed. Thus, a part of hydrocarbons decomposed in plasma form chemically active carbon-nitrogen bond and these molecules directly form the protection layer. On the other hand, the remaining part of hydrocarbons which are not decomposed or insufficiently decomposed during the above-mentioned process are chemically active also so that, before turned into a polymer state, those molecules are incorporated as protection layer depositing molecules to form the protection layer. As a consequence, production of particles can be suppressed.

According to a further study of the present inventors, it has also been found out that the temperature of a disk substrate upon deposition of the protection layer by plasma CVD (i.e., a disk substrate with at least a magnetic layer formed thereon) takes a part in suppression of production of the particles.

Based on the above-mentioned knowledge, the present inventors have completed the invention having the following aspects in order to remove the thermal asperity error, to reduce the magnetic spacing, and to achieve a high recording density.

First Aspect

According to a first aspect of this invention, there is provided a method of producing a magnetic disk, comprising the steps of forming at least a magnetic layer on a disk substrate, and thereafter forming a carbon-based protection layer by plasma CVD using a mixed gas of a hydrocarbon-based gas and a nitrogen gas without containing an inactive gas under the condition that the disk substrate with the magnetic layer formed thereon is kept at a temperature higher than 200° C.

Second Aspect

According to a second aspect of this invention, the mixed gas is a mixture of a low-molecular-weight straight-chain hydrocarbon-based gas and a nitrogen gas in the first aspect.

Third Aspect

According to a third aspect of this invention, the method in the first aspect further comprises the step of exposing the carbon-based protection layer to nitrogen plasma after the step of forming the carbon-based protection layer.

Fourth Aspect

According to a fourth aspect of this invention, a method in the third aspect further comprises the step of forming a lubrication layer after the step of exposing the carbon-based protection layer to nitrogen plasma.

Fifth Aspect

According to a fifth aspect of this invention, the magnetic disk is for use in a magnetic disk apparatus of a LUL (Load UnLoad) system in the first aspect.

A magnetic disk of this invention is produced by forming at least a magnetic layer on a disk substrate, and thereafter forming a carbon-based protection layer by plasma CVD (hereinafter referred to as P-CVD) using a mixed gas of a hydrocarbon-based gas and a nitrogen gas without containing an inactive gas under the condition that the disk substrate with the magnetic layer formed thereon is kept at a temperature higher than 200° C., as set forth in the first aspect.

When at least the magnetic layer is formed on the disk substrate and, thereafter, the protection layer is deposited by P-CVD under the condition that the disk substrate with the magnetic layer formed thereon is kept at a temperature higher than 200° C., it is possible to suppress production of particles during deposition of the protection layer. This is presumably because, if the temperature of the disk substrate during deposition of the protection layer is high, hydrocarbons decomposed in plasma tend to be active upon deposition on the disk substrate and are preferentially incorporated as protection layer depositing molecules rather than forming polymer particles to thereby form the protection layer. As a result, the production of particles can be suppressed.

Thus, the temperature of the disk substrate during deposition of the protection layer takes a role in suppressing production of particles. According to the study by the present inventors, the disk substrate is preferably heated to a temperature higher than 200° C., more preferably to a temperature higher than 230° C.

The carbon-based protection layer in this invention is a protection layer made of amorphous carbon, more specifically, a protection layer containing diamond-like amorphous carbon formed by P-CVD. By containing diamond-like carbon, the protection layer is given a hardness and a durability suitable therefor.

In this invention, the carbon-based protection layer is formed by P-CVD in which plasma is used to excite atoms. The carbon-based protection layer formed by P-CVD is high in denseness and hardness and is capable of preventing, for example, metal ions in the magnetic layer from migrating to the surface of the magnetic disk. Therefore, the carbon-based protection layer formed by P-CVD is particularly suitable for reduction in thickness of the protection layer.

In this invention, as a material gas for forming the carbon-based protection layer by P-CVD, a mixed gas of a hydrocarbon-based gas and a nitrogen gas is used. It is preferable to form diamond-like carbon by the use of the mixed gas.

In this case, the content of the nitrogen gas with respect to the hydrocarbon-based gas preferably falls within a range between 0.5% and 6%. The nitrogen gas being contained in the above-mentioned range suppresses the production of particles causing the thermal asperity so that the carbon-based protection layer excellent in LUL durability can be obtained. If the content of the nitrogen gas with respect to the hydrocarbon-based gas exceeds 6%, the particle suppressing effect is obtained but the amount of a graphite component in the protection layer may be increased to deteriorate the LUL durability. On the other hand, if the content of the nitrogen gas with respect to the hydrocarbon-based gas is smaller than 0.5%, the particle suppressing effect may be insufficient.

In this invention, the material gas is preferably a mixed gas of a low-molecular-weight straight-chain hydrocarbon-based gas and a nitrogen gas. Use of low-molecular-weight straight-chain hydrocarbons is preferable because, as the number of carbon atoms is increased, it is more difficult to vaporize hydrocarbons into a gas to be supplied to a deposition apparatus. In addition, as the number of carbon atoms is increased, decomposition during plasma discharge is difficult to thereby leave a greater amount of hydrocarbon polymers which are not decomposed or which are insufficiently decomposed. Use of cyclic hydrocarbons is unfavorable because decomposition during plasma discharge is difficult as compared with straight-chain hydrocarbons.

As the low-molecular-weight straight-chain hydrocarbons, use may be made of low-molecular-weight straight-chain saturated hydrocarbons and low-molecular-weight straight-chain unsaturated hydrocarbons. As the low-molecular-weight straight-chain saturated hydrocarbons, methane, ethane, propane, butane, octane, and the like may be used. As the low-molecular-weight straight-chain unsaturated hydrocarbons, ethylene, propylene, butylene, acetylene, and the like may be used. Herein, “low-molecular-weight” hydrocarbons means hydrocarbons in which the number of carbon atoms is 1 to 10 per one molecule, and may be called “light hydrocarbons”.

Among the low-molecular-weight straight-chain hydrocarbons mentioned above, use of acetylene is particularly preferable in this invention because the carbon-based protection layer which is dense and has a high hardness can be obtained.

In this invention, in order to control the content of hydrogen in the carbon-based protection layer formed by P-CVD, a hydrogen gas may appropriately be added to the mixed gas of the hydrocarbon-based gas and the nitrogen gas. If the carbon-based protection layer formed by P-CVD is a protection layer of diamond-like carbon containing hydrogen (hydrogenated diamond-like carbon), the denseness and the hardness of the protection layer can be improved.

As far as the effect of this invention is not decreased, any other appropriate gas component may be contained in the mixed gas of the hydrocarbon-based gas and the nitrogen gas.

In this invention, after the carbon-based protection layer containing hydrogen and nitrogen is formed by P-CVD using the mixed gas of the hydrocarbon-based gas and the nitrogen gas, the carbon-based protection layer may be exposed to nitrogen plasma to nitrogenate the surface of the protection layer to a high nitrogen concentration. According to the study of the present inventors, it has been found out that, by exposing the carbon-based protection layer to nitrogen plasma after forming the carbon-based protection layer containing hydrogen and nitrogen by P-CVD using the mixed gas of the hydrocarbon-based gas and the nitrogen gas, the particle suppressing effect is further improved. By increasing the concentration of nitrogen on the surface of the protection layer in the above-mentioned manner, it is possible to increase the adhesiveness between the protection layer and a lubrication layer in case where the lubrication layer is formed on the protection layer. In case where the surface of the protection layer is nitrogenated to a high concentration, the concentration of nitrogen on the surface of the protection layer need not specifically be limited. However, if the concentration of nitrogen on the surface of the protection layer is excessively high, the content of nitrogen in the protection layer as a whole is increased so that the LUL durability may be degraded. In view of the above, it is desirable that the concentration of nitrogen on the surface of the protection layer is not higher than, for example, 10 at %.

In the carbon-based protection layer formed by P-CVD, B/A of the Raman spectrum preferably falls within a range of 1.2 to 1.5. The Raman spectrum of the carbon-based protection layer can be measured by Raman spectroscopy. B/A of the Raman spectrum is a ratio between the maximum peak intensity (B) of the Raman spectrum as measured and the maximum peak intensity (A) of the Raman spectrum after removal of background due to photoluminescence. If B/A is smaller than 1.2, the denseness of the carbon-based protection layer may be lost. On the other hand, if B/A exceeds 1.5, the hardness of the carbon-based protection layer may be decreased. Therefore, if B/A falls within a range of 1.2 to 1.5, the carbon-based protection layer formed by P-CVD is further improved in denseness and hardness.

In this invention, it is preferable that the thickness of the carbon-based protection layer formed by P-CVD is not smaller than 1 nm. The thickness smaller than 1 nm may be insufficient to prevent migration of metal ions in the magnetic layer. The thickness of the carbon-based protection need not specifically be limited. However, in order not to inhibit the improvement in magnetic spacing, it is practically preferable that the thickness is not greater than 5 nm.

The magnetic disk in this invention may have a lubrication layer on the protection layer. The material of the lubrication layer is not specifically limited. However, those materials excellent in adhesiveness with the carbon-based protection layer are preferable. For example, a perfluoropolyether compound having a hydroxyl group as an end group is suitable. The perfluoropolyether compound has a straight-chain structure and exhibits a lubricating function suitable for a magnetic disk. In addition, the perfluoropolyether compound having a hydroxyl group (OH) as an end group exhibits a high adhesiveness with respect to the carbon-based protection layer. In particular, in case where the surface of the protection layer contains nitrogen, N⁺ on the surface of the protection layer and OH⁻ of the lubrication layer exhibit high affinity so as to achieve a high adhesiveness of the lubrication layer.

In this invention, an element forming the magnetic layer is not specifically limited but preferably is a cobalt (Co) alloy magnetic layer. The Co alloy magnetic layer has a high coercive force and a corrosion resistance and is therefore suitable for an increase in recording density. However, Co ions tend to escape into the protection layer and migrate to the surface of the magnetic disk. Therefore, in case where the thickness of the protection layer is reduced so as to decrease the spacing loss, a corrosion defect tends to occur. However, in this invention, the carbon-based protection layer formed by P-CVD is high in denseness and hardness so that, even if the protection layer is reduced in thickness, migration of metal ions of the magnetic layer to the surface of the magnetic disk is prevented. Therefore, the above-mentioned disadvantage can sufficiently be avoided.

As a Co-based alloy suitable in this invention, use may be made of a CoPt alloy, a CoCr alloy, and a CoCrPt alloy. Among them, a magnetic layer of the CoCrPt alloy is particularly suitable for an increase in recording density because magnetic grains can be reduced in size and the magnetic anisotropy constant of the grains can be improved.

In this invention, a glass substrate is preferably used as the disk substrate. This is because the glass substrate has a high flatness and smoothness and a high rigidity so as to meet the demand for a lower flying height of a magnetic head following an increase in recording density. As a material of the glass substrate, use may be made of, for example, an aluminosilicate glass, a soda lime glass, a soda aluminosilicate glass, an aluminoborosilicate glass, a borosilicate glass, a silica glass, a chain silicate glass, a glass ceramic such as a crystallized glass. Among them, the aluminosilicate glass is particularly preferable because it is excellent in shock resistance and vibration resistance.

By chemically strengthening the aluminosilicate glass, a compressive stress layer can be formed on the surface of the glass substrate. In this event, the transverse strength, the rigidity, the shock resistance, the vibration resistance, and the heat resistance are excellent and even under a high-temperature environment, precipitation of Na is avoided. In addition, the flatness is maintained and the Knoop hardness is excellent.

The glass substrate preferably has a thickness on the order between 0.1 mm and 1.5 mm.

By forming at least the magnetic layer and the carbon-based protection layer on the substrate, the magnetic disk of this invention is obtained. As a specific embodiment, the magnetic disk preferably comprises a seed layer, an underlayer, the magnetic layer, the carbon-based protection layer, and the lubrication layer formed on the substrate.

For example, the seed layer is formed by the use of an alloy having a bcc crystal structure or a B2 crystal structure, such as an Al alloy, a Cr alloy, an NiAl alloy, an NiAlB alloy, an AlRu alloy, an AlRuB alloy, an AlCo alloy, and an FeAl alloy, so that the magnetic grains can be reduced in size. Among them, the AlRu alloy, particularly, the alloy consisting of 30-70 at % Al and the balance Ru is preferable because the effect of reducing the size of the magnetic grains is excellent.

As the underlying layer, a layer which serves to adjust the orientation of the magnetic layer may be formed by the use of a Cr alloy, a CrMo alloy, a CrV alloy, a CrW alloy, a CrTi alloy, or a Ti alloy. Among them, the CrW alloy, particularly, the alloy consisting of 5-40 at % W and the balance Cr is preferable because of the effect of adjusting the orientation of the magnetic grains is excellent.

The details of other layers including the magnetic layer, the carbon-based protection layer, and the lubrication layer have already been described.

The method of forming the carbon-based protection layer in this invention has already been described. In order to deposit each of other layers, a known technique can be used. For example, use may be made of sputtering (DC magnetron sputtering, RF sputtering, and so on) and plasma CVD. The lubrication layer may be formed by a known technique, such as dipping, spraying, and spin coating.

After the carbon-based protection layer is formed, the surface of the disk may be cleaned with, for example, ultra pure water and isopropyl alcohol so that the surface quality of the disk can further be improved.

In this invention, the surface of the magnetic disk preferably has a surface roughness Rmax of 6 nm or less. If the surface roughness Rmax is greater than 6 nm, the decrease in magnetic spacing may be disadvantageously inhibited. The surface roughness Rmax herein referred to is defined in Japanese Industrial Standard (JIS) B0601 as a maximum height representative of a difference between a highest point and a lowest point of the surface and described in U.S. Pat. No. 6,544,893B2.

The magnetic disk in this invention is excellent in LUL durability and is suitable as a magnetic disk to be loaded in a magnetic disk apparatus of a LUL system.

### BRIEF DESCRIPTION OF THE INVENTION

A sole FIGURE is a schematic sectional view of a magnetic disk according to an embodiment of this invention.

### DESCRIPTION OF THE PREFERRED EMBODIMENT

Now, description will be made of this invention in conjunction with several specific examples. It is noted here that this invention is not limited to the following examples.

### Example 1

Referring to the sole FIGURE, a magnetic disk 10 in this example comprises a glass substrate 1 with a nonmagnetic metal layer 2 composed of a seed layer 2a and an underlayer 2b, a magnetic layer 3, a carbon-based protection layer 4, and a lubrication layer 5 successively laminated on the glass substrate 1.

Next, description will be made of a method of producing the magnetic disk 10 in this example.

At first, a molten glass was subjected to direct pressing by the use of an upper die, a lower die, and a body die to obtain a disk-shaped glass plate made of an aluminosilicate glass. The glass plate was subjected to grinding, precision polishing, end-face polishing, precision cleaning, and chemical strengthening. As a consequence, the glass substrate 1 for a magnetic disk was produced. The glass substrate 1 thus obtained was a substrate for a 2.5-inch magnetic disk and had an outer diameter of 65 mm, an inner diameter of 20 mm, and a thickness of 0.635 mm.

By the use of an atomic force microscope (AFM), the surface roughness of the glass substrate 1 obtained through the above-mentioned process was measured. As a result, it was confirmed that the glass substrate 1 had a flat and smooth surface having Rmax of 4.48 nm and Ra of 0.40 nm. The surface roughness Ra is also defined in Japanese Industrial Standard (JIS) B0601 as an arithmetic average roughness or a center-line-mean roughness and described in U.S. Pat. No. 6,544,893B2.

Next, by the use of a fixed-target deposition apparatus (static apparatus), the seed layer 2a, the underlayer 2b, and the magnetic layer 3 were successively formed on the glass substrate 1.

At first, by the use of an AlRu (Al: 50 at %, Ru: 50 at %) alloy as a sputtering target, the seed layer 2a of the AlRu alloy having a thickness of 30 nm was deposited on the glass substrate 1. Then, by the use of a CrMo (Cr: 80 at %, Mo: 20 at %) alloy as a sputtering target, the underlayer 2b of the CrMo alloy having a thickness of 20 nm was deposited on the seed layer 2a. Next, by the use of a CoCrPtB (Cr: 20 at %, Pt: 12 at %, B: 5 at %, the balance Co) alloy as a sputtering target, the magnetic layer 3 made of the CoCrPtB alloy having a thickness of 15 nm was deposited on the underlayer 2b.

Next, on the magnetic layer 3, the carbon-based protection layer 4 was formed by P-CVD. Specifically, the glass substrate 1 was heated by a heater system so that the temperature of the glass substrate 1 with the seed layer 2a, the underlayer 2b, and the magnetic layer 3 deposited thereon was equal to 250° C. upon formation of the protection layer 4. The temperature of the glass substrate 1 was confirmed by the use of a radiation thermometer through a window of a deposition chamber immediately before formation of the protection layer 4. For example, the glass substrate 1 may be heated at the time instant before deposition of the underlayer 2b.

Using a gas obtained by mixing acetylene and nitrogen in a ratio of 97%:3% as a material gas, deposition was carried out by P-CVD so that the protection layer 4 made of diamond-like amorphous carbon containing hydrogen and nitrogen and having a thickness of 3.5 nm was formed on the magnetic layer 3.

At this time, a high-frequency power (having a frequency of 27 MHz) was applied to an electrode to produce plasma. During deposition, the degree of vacuum fell within a range between 5×10⁻⁷ and 5×10⁻⁸ mb. Deposition by P-CVD may be carried out as IBD (Ion Beam Deposition) by applying an electric voltage to the plasma.

After the carbon-based protection layer 4 was formed by P-CVD, a nitrogen gas alone was introduced into the plasma to expose the protection layer 4 to nitrogen plasma (nitrogen plasma treatment). The protection layer 4 subjected to nitrogen plasma treatment had a thickness of 0.5 nm as a result of measurement by a transmission electronic microscope.

After the carbon-based protection layer 4 was formed, the Raman spectroscopy was carried out. As a result, B/A was equal to 1.36. The Raman spectroscopy was carried out in the following manner.

At first, the surface of the carbon-based protection layer 4 was irradiated by an Ar ion laser having a wavelength of 514.5 nm. Then, the Raman spectrum appearing in a frequency range (wave number range) between 900 cm⁻¹ and 1800 cm⁻¹ due to Raman scattering was observed. Herein, the peak intensity of the maximum peak appearing in the frequency range between 900 cm⁻¹ and 1800 cm⁻¹ was represented by B. Next, the background appearing in the Raman spectrum and assumed to be photoluminescence was removed. Specifically, the intensity of the photoluminescence was calculated based on the detected intensity around 900 cm⁻¹ and the detected intensity around 1800 cm⁻¹ and subtracted from the Raman spectrum. The peak intensity of the maximum peak after removal of the background was represented by A. The ratio of the intensity B with respect to the intensity A was obtained as B/A.

Furthermore, by the X-ray photoelectron spectroscopy (XPS), the carbon-based protection layer 4 was analyzed. As a result, the concentration of nitrogen with respect to carbon was equal to 8.5 at %.

Next, the disk with the seed layer 2a, the underlayer 2b, the magnetic layer 3, and the carbon-based protection layer 4 formed thereon was dipped and cleaned in pure water kept at 70° C. for 400 seconds, thereafter cleaned with isopropyl alcohol (IPA) for 400 seconds, and then dried by IPA vapor as finishing dry.

Next, on the carbon-based protection layer 4 after cleaning, the lubrication layer 5 of a PFPE (perfluoropolyether) compound was formed by dipping. Specifically, use was made of an alcohol-modified Fomblin® Z derivative manufactured by Ausimont. This compound has a PFPE main chain and one or two hydroxyl groups at each of opposite ends thereof, i.e., two to four hydroxyl group per a single molecule. The lubricant layer 5 had a thickness of 1 nm.

As described above, the magnetic disk 10 in this example was produced.

By the use of the atomic force microscope (AFM), the surface roughness of the magnetic disk 10 thus obtained was measured. As a result, it has been confirmed that the magnetic disk 10 had a flat and smooth surface having Rmax of 4.61 nm and Ra of 0.41 nm.

Furthermore, the glide height of the magnetic disk 10 was measured and was equal to 4.7 nm. In order that the flying height of a magnetic head is stably kept at 12 nm or less, the glide height of the magnetic disk is desirably equal to 6 nm or less.

The magnetic disk 10 thus obtained was further subjected to various performance tests as follows.

Particle Count Test

The above-mentioned magnetic disk was set in a light scattering particle counter and the number of particles on the surface of the magnetic disk was measured. Generally, it is required that the particle count is not greater than 50/disk. If a greater number of particles are present on the magnetic disk, an error is detected upon initial error registration when the magnetic disk is mounted to the magnetic disk apparatus. In the magnetic disk in this example, the particle count was equal to 30/disk.

Thermal Asperity Test

The thermal asperity test was carried out in the following manner. The above-mentioned magnetic disk and a magnetic head having a giant magnetoresistive read element (GMR element) were mounted to a magnetic recording apparatus. The number of rotation of the magnetic disk was 5400 rpm. As a slider of the magnetic head, a NPAB (Negative Pressure Air Bearing) slider was used. The flying height of the magnetic head was 12 nm. Under the above-mentioned condition, recording/reproducing (read/write) operations were carried out by the magnetic head. The number of points where the thermal asperity occurs was counted with respect to the surface of the magnetic disk (TA count). Generally, it is required that the TA count is not greater than 5 per the surface of the magnetic disk. In the magnetic disk in this example, the TA count was equal to 0/disk.

LUL Durability Test

The LUL durability test was carried out in the following manner. The above-mentioned magnetic disk and a magnetic head having a giant magnetoresistive read element (GMR element) were mounted to a magnetic recording apparatus. The number of rotation of the magnetic disk was 5400 rpm. As a slider of the magnetic head, a NPAB (Negative Pressure Air Bearing) slider was used. The flying height of the magnetic head was 12 nm. Under a high-temperature high-humidity environment of 70° C. and 80% RH (Relative Humidity) within the magnetic recording apparatus, load and unload (LUL) operations of the magnetic head were consecutively and repeatedly carried out. By measuring the number of times of the LUL operations without any failure caused in the magnetic recording apparatus, the LUL durability was evaluated.

In the magnetic disk of this embodiment, the number of times of the LUL operations exceeded 1,000,000 without any failure. Generally, in the LUL durability test, it is required that the number of times of the LUL operations exceeds consecutive 400,000 times without any failure. In a normal working environment of the HDD, the use for about 10 years is required until the number of times of LUL operations exceeds 400,000.

The results of various performance tests upon the magnetic disk in this example are collectively shown in Table 1.

TABLE 1

| | | | | nitrogen | nitrogen | particle | thermal | LUL durability test |
|---|---|---|---|---|---|---|---|---|
| | material gas | inactive | substrate | plasma | concen- | count | asperity test | number of times |
| | acetylene:nitrogen | gas | temperature | treatment | tration | per disk | TA count/disk | of LUL operations |
| Example 1 | 97%:3% | not | 250° C. | 0.5 nm | 8.5 at % | 30 | 0 | withstood 1000000 times |
| | | contained | | | | | | |
| Example 2 | 94%:6% | not | 250° C. | no | 12.0 at % | 20 | 0 | withstood 400000 times |
| | | contained | | | | | | |
| Example 3 | 97%:3% | not | 250° C. | no | 7.5 at % | 43 | 2 | withstood 600000 times |
| | | contained | | | | | | |
| Example 4 | 97%:3% | not | 290° C. | 0.5 nm | 8.5 at % | 25 | 0 | withstood 1000000 times |
| | | contained | | | | | | |
| Example 5 | 97%:3% | not | 230° C. | 0.5 nm | 8.5 at % | 32 | 1 | withstood 600000 times |
| | | contained | | | | | | |
| Example 6 | 97%:3% | not | 220° C. | 0.5 nm | 8.5 at % | 35 | 3 | withstood 600000 times |
| | | contained | | | | | | |
| Example 7 | 97%:3% | not | 210° C. | 0.5 nm | 8.5 at % | 40 | 5 | withstood 400000 times |
| | | contained | | | | | | |
| Comparative | 100%:0% | not | 250° C. | no | 0.0 at % | 550 | 35 | failed after 200000 times |
| Example 1 | | contained | | | | | | |
| Comparative | 97%:3% | not | 200° C. | no | 7.5 at % | 60 | 6 | failed after 200000 times |
| Example 2 | | contained | | | | | | |
| Comparative | 100%:0% | contained | 250° C. | no | 0.0 at % | 1100 | 80 | failed after 100000 times |
| Example 3 | | | | | | | | |
| Comparative | 97%:3% | contained | 250° C. | no | 7.5 at % | 100 | 15 | failed after 200000 times |
| Example 4 | | | | | | | | |
| Comparative | 97%:3% | contained | 250° C. | 0.5 nm | 8.5 at % | 80 | 11 | failed after 200000 times |
| Example 5 | | | | | | | | |

### Example 2

A magnetic disk in Example 2 was produced in the manner similar to the magnetic disk in Example 1 except that the ratio of the acetylene gas and the nitrogen gas was 94% :6 % upon formation of the carbon-based protection layer 4 and that the nitrogen plasma treatment was not carried out after deposition of the protection layer.

The magnetic disk in Example 2 was subjected to various performance evaluation tests in the manner similar to Example 1 and the results are shown in Table 1.

### Example 3

A magnetic disk in Example 3 was produced in the manner similar to the magnetic disk in Example 1 except that the nitrogen plasma treatment was not carried out after deposition of the protection layer 4.

The magnetic disk in Example 3 was subjected to various performance evaluation tests in the manner similar to Example 1 and the results are shown in Table 1.

### Examples 4-7

Magnetic disks were produced in the manner similar to the magnetic disk in Example 1 except that the temperature of the substrate upon deposition of the carbon-based protection layer 4 was changed to 290° C. (Example 4), 230° C. (Example 5), 220° C. (Example 6), and 210° C. (Example 7), respectively.

The magnetic disks in Examples 4-7 were subjected to various performance evaluation tests in the manner similar to Example 1 and the results are shown in Table 1.

### Comparative Example 1

A magnetic disk in Comparative Example 1 was produced in the manner similar to the magnetic disk in Example 1 except that an acetylene gas alone was used as a material gas upon formation of the carbon-based protection layer 4 and that the nitrogen plasma treatment after deposition of the protection layer 4 was not carried out.

The magnetic disk in Comparative Example 1 was subjected to various performance evaluation tests in the manner similar to Example 1 and the results are shown in Table 1.

### Comparative Example 2

A magnetic disk in Comparative Example 2 was produced in the manner similar to the magnetic disk in Example 1 except that the temperature of the substrate upon deposition of the carbon-based protection layer 4 was changed to 200° C. and that the nitrogen plasma treatment was not carried out.

The magnetic disk in Comparative Example 2 was subjected to various performance evaluation tests in the manner similar to Example 1 and the results are shown in Table 1.

### Comparative Example 3

A magnetic disk in Comparative Example 3 was produced in the manner similar to the magnetic disk in Example 1 except that a mixed gas of an acetylene gas and an Ar gas as an inactive gas (the ratio of the Ar gas being 3% with respect to the acetylene gas) was used as a material gas upon formation of the carbon-based protection layer 4 and that the nitrogen plasma treatment after deposition of the protection layer 4 was not carried out.

The magnetic disk in Comparative Example 3 was subjected to various performance evaluation tests in the manner similar to Example 1 and the results are shown in Table 1.

### Comparative Example 4

A magnetic disk in Comparative Example 4 was produced in the manner similar to the magnetic disk in Example 1 except that a mixture of a mixed gas of an acetylene gas and a nitrogen gas (the ratio of the acetylene gas and the nitrogen gas being same as that in Example 1) and an Ar gas (the ratio of the Ar gas being 3% with respect to the mixed gas of acetylene and nitrogen) and that the nitrogen plasma treatment after deposition of the protection layer 4 was not carried out.

The magnetic disk in Comparative Example 4 was subjected to various performance evaluation tests in the manner similar to Example 1 and the results are shown in Table 1.

### Comparative Example 5

A magnetic disk in Comparative Example 5 was produced in the manner similar to the magnetic disk in Comparative Example 4 except that the nitrogen plasma treatment was carried out after deposition of the carbon-based protection layer 4.

The magnetic disk in Comparative Example 5 was subjected to various performance evaluation tests in the manner similar to Example 1 and the results are shown in Table 1.

Referring to the results in Table 1, the following will be understood.

From the results in Examples 1 to 3, it is understood that, if the carbon-based protection layer is formed by P-CVD using a mixed gas of a hydrocarbon-based gas and a nitrogen gas without containing an inactive gas, the magnetic disk which is suppressed in production of particles and prevented from the thermal asperity error and which is excellent in LUL durability can be obtained.

From the results in Examples 1 and 4 to 7, it is understood that, if the temperature of the substrate upon deposition of the carbon-based protection layer exceeds 200° C., the particle suppressing effect is obtained and that, if the temperature of the substrate is not lower than 230° C., the effect is much greater.

On the other hand, in Comparative Example 1 using the acetylene gas alone as the material gas without containing the nitrogen gas, production of particles can not be suppressed and the thermal asperity error can not be prevented. In addition, the LUL durability is inferior.

In Comparative Example 2 in which the temperature of the substrate upon deposition of the carbon-based protection layer is 200° C., the particle suppressing effect is small.

In Comparative Example 3 in which a mixed gas containing the acetylene gas with the Ar gas introduced therein was used as the material gas, a very large amount of particles were produced and the thermal asperity error occurred. The LUL durability was further inferior as compared with Comparative Example 1. In Comparative Examples 4 and 5 in which a mixture of the mixed gas of acetylene and nitrogen and the Ar gas introduced therein was used as the material gas, a large amount of particles were produced as a result of introducing the Ar gas, although the nitrogen gas was introduced. Therefore, the thermal asperity error is not prevented. In addition, the LUL durability was inferior.

As thus far been described in detail, in the method of producing a magnetic disk according to this invention, it is possible to suppress production of particles upon formation of the carbon protection layer by P-CVD and to prevent the thermal asperity error. Furthermore, the magnetic disk very excellent in LUL durability is obtained. Thus, the method is suitable for a magnetic disk apparatus of a LUL system and enables an increase in capacity of the magnetic disk apparatus. The magnetic disk obtained in this invention is suitable for achievement of a reduced thickness of the protection layer and a lower flying height of the magnetic head. As a consequence, the magnetic spacing can be decreased and an increase in recording density can be achieved.

Although this invention has thus far been described in conjunction with several specific examples, it will readily be possible for those skilled in the art to put this invention into practice in various other manners without departing the scope of appended claims.

What is claimed is:

1. A method of producing a magnetic disk, comprising:
forming at least a magnetic layer on a disk substrate, and
thereafter forming a carbon-based protection layer by plasma CVD using a mixed gas of a hydrocarbon-based gas and a nitrogen gas without containing an inactive gas under the condition that the disk substrate with the magnetic layer formed thereon is kept at a temperature higher than 200° C.

2. A method according to claim 1, wherein:
the mixed gas is a mixture of a low-molecular-weight straight-chain hydrocarbon-based gas and a nitrogen gas.

3. A method according to claim 1, further comprising:
exposing the carbon-based protection layer to nitrogen plasma after forming the carbon-based protection layer.

4. A method according to claim 3, further comprising:
forming a lubrication layer after exposing the carbon-based protection layer to nitrogen plasma.

5. A method according to claim 1, wherein
the magnetic disk is for use in a magnetic disk apparatus of a load/unload system.
